(19) United States
(12) Patent Application Publication
(10) Pub. No.: US 2012/0045212 A1
(43) Pub. Date: Feb. 23, 2012

(54) OPTICAL AMPLIFICATION DEVICE, COMMUNICATION SYSTEM, AND AMPLIFICATION METHOD

(75) Inventor: Tomoaki TAKEYAMA, Kawasaki (JP)

(73) Assignee: Fujitsu Limited, Kawasaki (JP)

(21) Appl. No.: 13/179,872

(22) Filed: Jul. 11, 2011

(30) Foreign Application Priority Data
Aug. 18, 2010 (JP) 2010-183040

(51) Int. Cl. H01S 3/102; H01S 3/14; H04J 14/02; H01S 3/091

(52) U.S. Cl. 398/79; 359/342; 359/337.11; 359/337.5

(57) ABSTRACT

According to an aspect of the invention, an amplification device includes an amplifier configured to amplify a signal light by inputting the signal light and an excitation light to a rare-earth doped amplification medium, a wavelength arrangement monitor configured to acquire wavelength arrangement information indicating a wavelength of the signal light, and a light power controller configured to control power of the input excitation light based on the acquired wavelength arrangement information.

### CROSS-REFERENCE TO RELATED APPLICATIONS

This application is based upon and claims the benefit of priority of the prior Japanese Patent Application No. 2010-183040, filed on Aug. 18, 2010, the entire contents of which are incorporated herein by reference.

### FIELD

The embodiments discussed herein are related to an amplification device configured to amplify light, a communication system, and an amplification method.

### BACKGROUND

As the multimedia network technology moves forward, the communication traffic is in increasing demand and wavelength division multiplexing (WDM) communication systems transferring a WDM signal subjected to the WDM are used. In the WDM communication system, an optical amplifier using an optical fiber such as an erbium doped fiber (EDF) as an amplification medium is used. Further, because of increasing demand for the transfer capacity, communication systems with a data rate of about 40 [Gbps] have been studied.

In the WDM communication system, collective compensation for losses occurring in a path provided to transfer the WDM signal subjected to the WDM is made with a WDM amplifier, and the wavelength multiplexing/demultiplexing is performed with an arrayed waveguide grating (AWG) for example. After that, a variable dispersion compensator (VDC) makes compensation for the wavelength dispersion for each of optical signals that are obtained through the wavelength multiplexing/demultiplexing. The VDC is often referred to as a tunable dispersion compensator (TDC).

When a single VDC makes collective compensation for the dispersion of each of WDM signals as mentioned above, dispersion compensation errors occur by wavelengths. Since a small dispersion compensation error is permissible in a high-speed (e.g., about 40 [Gbps]) communication system, the VDC may make the dispersion compensation for each wavelength.

Since the loss of the WDM signal, which occurs in the VDC or the AWG, is significant, a single-wave amplifier is provided in the anteceding stage and compensation for the loss is made. After that, the WDM signal is transmitted to a receiver. The single-wave amplifier may be a single-wave amplifier provided for each of signal wavelengths of the WDM signal in view of the stocks of customers.

Further, related technologies of keeping the gain characteristic constant and attaining a wide input dynamic range have been available (see Japanese Laid-Open Patent Publication No. 2005-192256, for example). The technology disclosed in Japanese Laid-Open Patent Publication No. 2005-192256 provides a gain adjuster configured to detect a deviation from the target gain of a first variable gain of a first optical amplifier and adjust a second variable gain of a second optical amplifier so that the sum of the first and second variable gains is kept constant, which makes compensation for the detected deviation.

According to the above-described related technology, however, the signal (S)/amplified spontaneous emission (ASE) ratio of a signal light is deteriorated due to an ASE light occurring in the preceding stage of a receiver. The S/ASE ratio is the ratio between the power of the signal and that of the ASE light. The ASE light occurs in, for example, an optical amplifier. When the S/ASE ratio is deteriorated, the reception quality of the receiver is decreased.

### SUMMARY

According to an aspect of the invention, an amplification device includes an amplifier configured to amplify a signal light by inputting the signal light and an excitation light to a rare-earth doped amplification medium, a wavelength arrangement monitor configured to acquire wavelength arrangement information indicating a wavelength of the signal light, and a light power controller configured to control power of the input excitation light based on the acquired wavelength arrangement information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary configuration of an amplification device according to an embodiment.

FIG. 2 illustrates exemplary operations that are performed with an amplification device according to an embodiment.

FIG. 3 illustrates an exemplary wavelength gain characteristic of an EDF.

FIG. 4 illustrates an exemplary relationship between a signal wavelength and the target value of output power of the EDF.

FIG. 5A illustrates a wavelength output characteristic of the EDF, the wavelength output characteristic being attained when the signal wavelength is relatively short.

FIG. 5B illustrates another wavelength output characteristic of the EDF, the wavelength output characteristic being attained when the signal wavelength is relatively long.

FIG. 6A illustrates a wavelength output characteristic of a VOA, the wavelength output characteristic being attained when the signal wavelength is relatively short.

FIG. 6B illustrates another wavelength output characteristic of the VOA, the wavelength output characteristic being attained when the signal wavelength is relatively long.

FIG. 7A illustrates the relationship between the signal wavelength and the S/ASE ratio.

FIG. 7B illustrates the improvement amount of the S/ASE ratio.

FIG. 8 illustrates a specific example of the relationship between the signal wavelength and the output power of the EDF.

FIG. 9 illustrates the relationship between the signal wavelength and the attenuation amount of the VOA.

FIG. 10 illustrates a communication system according to an embodiment.

FIG. 11 illustrates an exemplary modification 1 of an amplification device according to an embodiment.

FIG. 12 illustrates an exemplary modification 2 of an amplification device according to an embodiment.

FIG. 13 illustrates an exemplary modification 3 of an amplification device according to an embodiment.

FIG. 14 illustrates an exemplary wavelength attenuation characteristic of a wavelength filter.

FIG. 15 illustrates an exemplary modification 4 of an amplification device according to an embodiment.

### DESCRIPTION OF EMBODIMENTS

Hereinafter, preferred embodiments of disclosed technologies will be described in detail with reference to the attached drawings.

### EMBODIMENTS

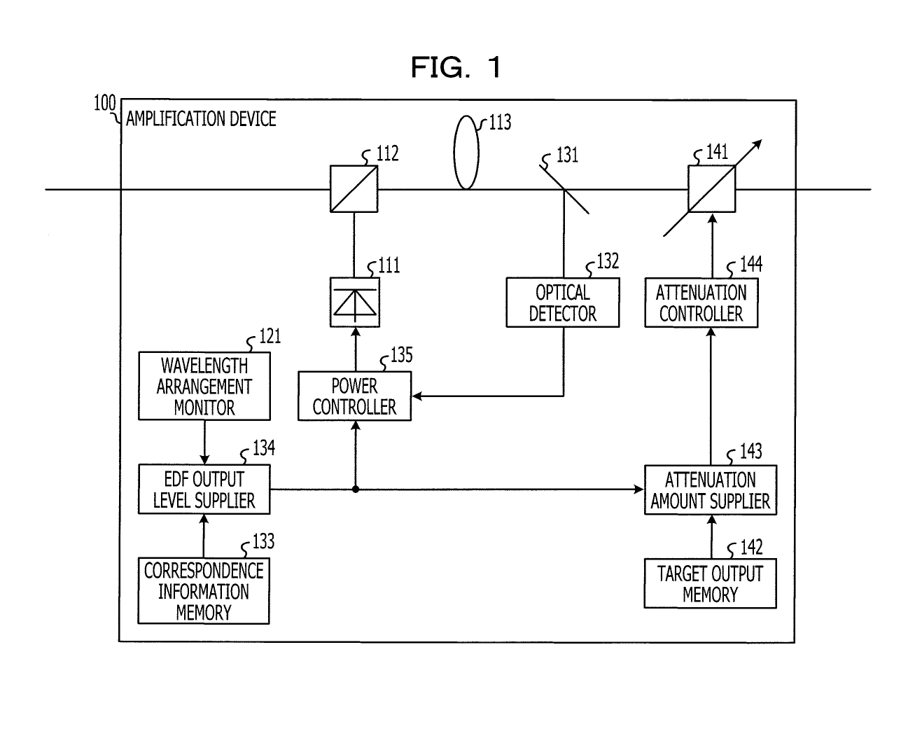

FIG. 1 illustrates an exemplary configuration of an amplification device 100 according to an embodiment. As illustrated in FIG. 1, the amplification device 100 includes an excitation light source 111, a wavelength division multiplexer 112, an EDF 113, a wavelength arrangement monitor 121, a splitter 131, an optical detector 132, a correspondence information memory 133, an EDF output level supplier 134, a power controller 135, a variable optical attenuator (VOA) 141, a target output memory 142, an attenuation amount supplier 143, and an attenuator controller 144.

The excitation light source 111 and the multiplexer 112 function as an amplifier configured to input a signal light and an excitation light into a rare-earth doped amplification medium to amplify the signal light. More specifically, the excitation light source 111 generates and outputs the excitation light to the multiplexer 112. The power (inverted distribution ratio) of the generated excitation light is controlled by, for example, the power controller 135. The excitation light source 111 may include, for example, a laser diode (LD).

The multiplexer 112 multiplexes the signal light input to the amplification device 100 and the excitation light output from the excitation light source 111. The multiplexer 112 outputs light obtained through the multiplexing to the EDF 113, which is a rare earth-doped amplification medium. The EDF 113 lets the output light pass therethrough so that the light is output to the splitter 131. Thus, the EDF 113 amplifies the signal light based on the power of the excitation light and outputs the amplified light to the splitter 131.

The wavelength arrangement monitor 121 may acquire wavelength arrangement information indicating the wavelength of the signal light input to the amplification device 100 (signal wavelength λ). The wavelength arrangement monitor 121 outputs the acquired wavelength arrangement information to the EDF output level supplier 134. For example, the wavelength arrangement information may be stored in the memory of the amplification device 100 and the wavelength arrangement monitor 121 may acquire the wavelength arrangement information stored in the memory of the amplification device 100.

In another case, the wavelength arrangement monitor 121 may acquire the wavelength arrangement information from an external control device. For example, the wavelength arrangement monitor 121 may obtain wavelength arrangement information via an optical supervisory channel.

The splitter 131 and the optical detector 132 function as a monitor configured to monitor the power of the signal light amplified with the EDF 113. More specifically, the splitter 131 causes the signal light output from the EDF 113 to branch and outputs signal lights that are obtained through the branching to the individual VOA 141 and optical detector 132. The optical detector 132 converts the signal light output from the splitter 131 into an electric signal. The optical detector 132 outputs the electric signal obtained through the conversion to the power controller 135. The optical detector 132 may include, for example, a photodiode.

The correspondence information memory 133 is a power memory provided to store correspondence information making the signal light wavelength (signal wavelength λ) and a target value Pedf of the output power of the EDF 113 correspond to each other. The correspondence information may be provided as table data indicating the correspondence between the signal wavelength λ, and the target value Pedf or a relational expression calculating the target value Pedf of the output power based on the signal wavelength λ. Further, according to the correspondence information stored in the correspondence information memory 133, a target value Pedf corresponding to a relatively short signal wavelength λ is larger than that corresponding to a relatively long signal wavelength λ.

The EDF output level supplier 134 determines the target value Pedf of the output power of the EDF 113 based on the wavelength arrangement information output from the wavelength arrangement monitor 121 and the correspondence information stored in the correspondence information memory 133. More specifically, the EDF output-level supplier 134 acquires the target value Pedf corresponding to a signal wavelength λ indicated by the wavelength arrangement information from the correspondence information. The EDF output-level supplier 134 supplies information about the acquired target value Pedf to each of the power controller 135 and the attenuation amount supplier 143.

The power controller 135 controls the power of the excitation light output from the excitation light source 111 so that the value of power of the electric signal output from the optical detector 132 becomes that of the target value Pedf information output from the EDF output-level supplier 134. Consequently, it becomes possible to control the power of the excitation light input to the EDF 113 based on the wavelength arrangement information acquired with the wavelength arrangement monitor 121.

The VOA 141 attenuates (loses) the signal light output from the splitter 131 by as much as a variable attenuation amount.

The VOA 141 outputs the attenuated signal light to the anteceding stage of the amplification device 100. The attenuation amount attained with the VOA 141 is controlled with the attenuation controller 144, for example.

The target output memory 142, the attenuation amount supplier 143, and the attenuation controller 144 function as an attenuation controller provided to control the attenuation amount attained with the VOA 141 so that the power of the signal light output from the VOA 141 becomes constant. More specifically, the target output memory 142 stores information about the target value Pout of power of the signal light output from the amplification device 100.

The attenuation amount supplier 143 determines an attenuation amount Lvoa attained with the VOA 141 based on the target value Pout information stored in the target output memory 142 and the target value Pedf information output from the EDF output-level supplier 134. For example, the attenuation amount supplier 143 calculates the attenuation amount Lvoa in accordance with the equation Lvoa=Pedf−Pout. Consequently, the attenuation supplier 13 can determine the attenuation amount Lvoa by which the power of the signal light output from the VOA 141 becomes the target value Pout. The attenuation amount supplier 143 supplies information about the determined attenuation amount Lvoa to the attenuation controller 144.

The attenuation controller 144 controls the attenuation amount attained with the VOA 141 based on the attenuation amount Lvoa information output from the attenuation amount supplier 143. Thus, the attenuation amount supplier 143 and the attenuation controller 144 control the attenuation amount attained with the VOA 141 based on the difference between the target value Pedf of the output power of the EDF 113 and the target value Pout of the power of the signal light output from the amplification device 100.

Consequently, it becomes possible to keep the output power of the amplification device 100 constant at the target value Pedf even though the power of the excitation light is controlled with the power controller 135. Further, since the attenuation amount attained with the VOA 141 is controlled based on the target value Pedf of the output power of the EDF 113, it becomes possible to keep the output power of the amplification device 100 constant without providing, for example, a monitor configured to monitor the output power of the VOA 141. Accordingly, the electronic circuit scale is reduced.

Each of the above-described EDF output-level supplier 134, power controller 135, attenuation amount supplier 143, and attenuation controller 144 may include at least one circuit such as a field-programmable gate array (FPGA) and/or at least one processor such as a digital signal processor (DSP), for example. Further, each of the correspondence information memory 133 and the target output memory 142 may include at least one memory.

According to the above-described configuration, the EDF 113 is provided in the anteceding stage of the multiplexer 112 to achieve forward excitation. According to a different configuration, however, the EDF 113 may be provided in the preceding stage of the multiplexer 112 to achieve backward excitation. In that case, the multiplexer 112 inputs the excitation light output from the excitation light source 111 to the EDF 113 so that the signal light and the excitation light pass through the EDF 113 in the reverse direction. The latter configuration can also amplify the signal light.

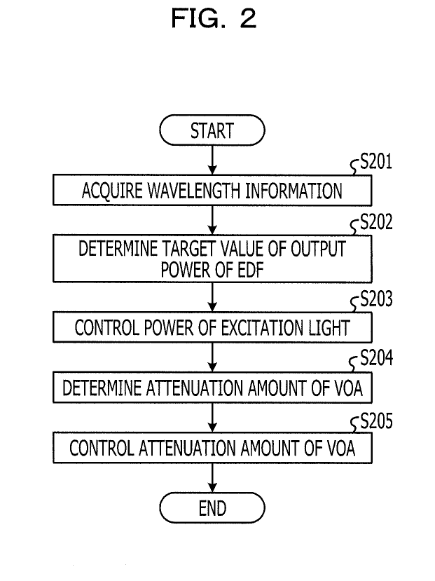

FIG. 2 illustrates a series of exemplary operations performed with an amplification device according to an embodiment. The wavelength arrangement monitor 121 may comprise a processor. As illustrated in FIG. 2, first, the wavelength arrangement monitor 121 acquires the wavelength arrangement information indicating the signal wavelength λ (operation S201). Next, the EDF output-level supplier 134 determines the target value Pedf of the output power of the EDF 113 based on the wavelength arrangement information acquired at operation S201 and the correspondence information stored in the correspondence information memory 133 (operation S202).

Next, the power controller 135 controls the power of the excitation light so that the power of the electric signal output from the optical detector 132 attains the target value Pedf determined at operation S202 (operation S203).

Next, the attenuation amount supplier 143 determines the attenuation amount Lvoa attained with the VOA 141 based on the target value Pedf determined at operation S202 and the target value Pout information stored in the target output memory 142 (operation S204). Next, the attenuation controller 144 controls the attenuation amount attained with the VOA 141 so that the attenuation amount Lvoa determined at operation S204 is attained (operation S205). Then, the series of exemplary operations is finished. The above-described operations allow for controlling the power of the excitation light based on the signal wavelength 2, and controlling and keeping the power of the signal light output from the amplification device 100 constant. The above-described operations are performed when the amplification device 100 is started. Further, the above-described operations may be performed repeatedly while the amplification device 100 is operated.

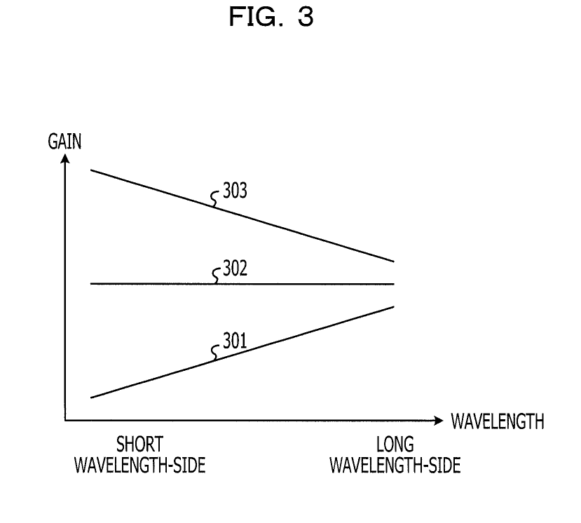

FIG. 3 illustrates exemplary wavelength gain characteristics of the EDF 113. In FIG. 3, the horizontal axis indicates the optical wavelength and the vertical axis indicates the optical gain. Each of wavelength gain characteristics 301, 302, and 303 indicates the gain characteristic corresponding to the wavelength of a light input to the EDF 113. According to the wavelength gain characteristic 301, the gain of the EDF 113 is increased as the wavelength becomes longer.

The wavelength gain characteristic 302 indicates a wavelength gain characteristic attained when the power of an excitation light (excitation state) input to the EDF 113 is higher than that corresponding to the wavelength gain characteristic 301. According to the wavelength gain characteristic 302, the gain of the EDF 113 becomes substantially constant with reference to the wavelength. The wavelength gain characteristic 303 indicates a wavelength gain characteristic attained when the power of an excitation light input to the EDF 113 is higher than that corresponding to the wavelength gain characteristic 302. According to the wavelength gain characteristic 303, the gain of the EDF 113 is decreased as the wavelength becomes longer.

Thus, each of the wavelength gain characteristics of the EDF 113 is changed based on the power of an input excitation light. Therefore, when the signal wavelength λ is obtained on the short-wavelength side of the signal band, it becomes possible to make the gain of the signal wavelength λ relatively higher by increasing the excitation light power so that the wavelength gain characteristic of the EDF 113 becomes substantially or exactly equivalent to the wavelength gain characteristic 303. Further, when the signal wavelength λ is obtained on the long-wavelength side of the signal band, it becomes possible to make the gain of the signal wavelength λ, relatively higher by decreasing the excitation light power so that the wavelength gain characteristic of the EDF 113 becomes substantially or exactly equivalent to the wavelength gain characteristic 301.

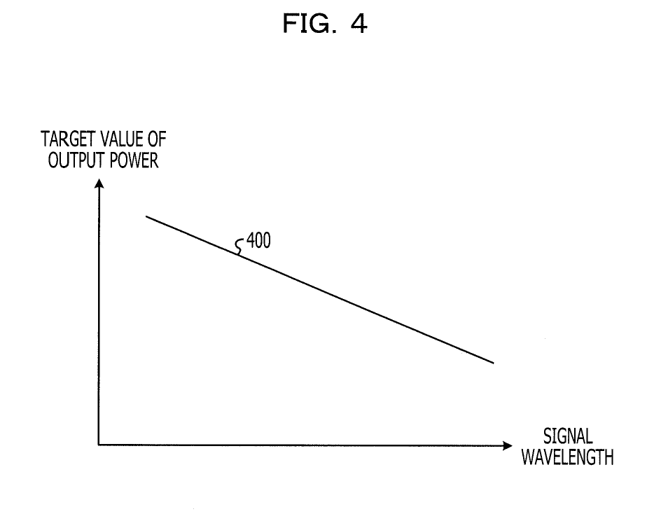

FIG. 4 illustrates an exemplary relationship between the signal wavelength and the target value of the output power of the EDF 113.

In FIG. 4, the horizontal axis indicates the signal wavelength λ and the vertical axis indicates the target value Pedf of the output power of the EDF 113. A relationship 400 indicates the relationship between the signal wavelength 2 and the target value Pedf.

According to the relationship 400, the target value Pedf is expressed as a linear gradient with reference to the signal wavelength λ, and the target value Pedf is increased as the signal wavelength becomes shorter. The correspondence information memory 133 stores correspondence information indicating the relationship 400.

The correspondence information indicating the relationship 400 is correspondence table data making the signal wavelength λ, and the target value Pedf correspond to each other, where the correspondence table data is generated by discretizing the relationship 400, for example. Further, the correspondence information indicating the relationship 400 may be the relational expression Pedf=aλ+b indicating the relationship 400 as a linear function. Each of the signs a and b is a coefficient, and the sign a is a negative coefficient in the above-described embodiment. Accordingly, the power of the excitation light is increased as the signal wavelength λ becomes shorter, and the gain attained on the short wavelength-side of the signal band becomes larger than that attained on the long wavelength-side of the signal band. Further, the power of the excitation light is decreased as the signal wavelength λ becomes longer, and the gain attained on the long wavelength-side of the signal band becomes larger than that attained on the short wavelength-side of the signal band.

In the above-described embodiment, the target value Pedf is continuously increased as the signal wavelength λ becomes shorter. However, when the signal wavelength is relatively short, the target value Pedf may be increased more than that attained when the signal wavelength λ is relatively long. For example, when the signal wavelength λ is obtained on the long wavelength-side relative to the center wavelength of the signal band, the target value Pedf may be determined to be a constant value A, and when the signal wavelength λ is obtained on the short wavelength-side relative to the center wavelength of the signal band, the target value Pedf may be determined to be a constant value B (>A).

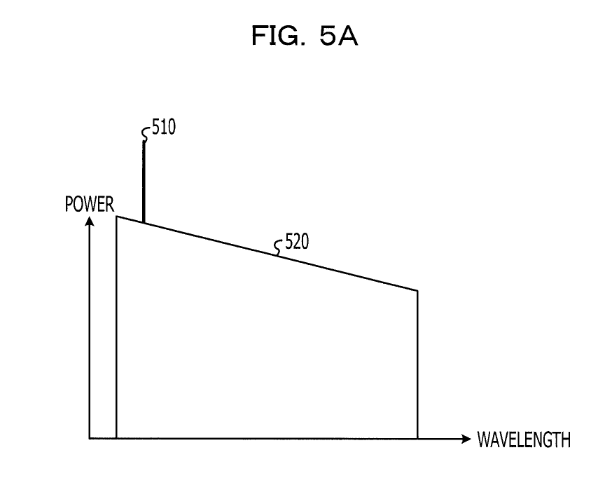

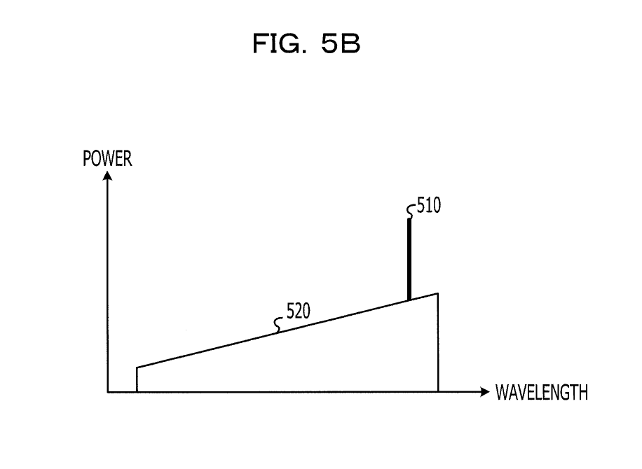

FIG. 5A is a graph illustrating a wavelength output characteristic of the EDF 113, the wavelength output characteristic being attained when the signal wavelength is relatively short.

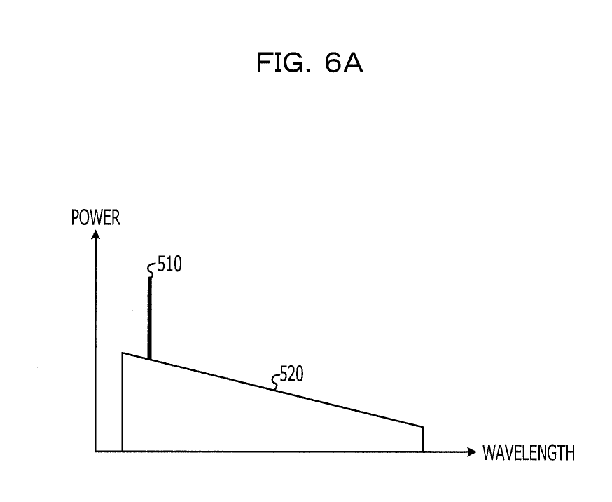

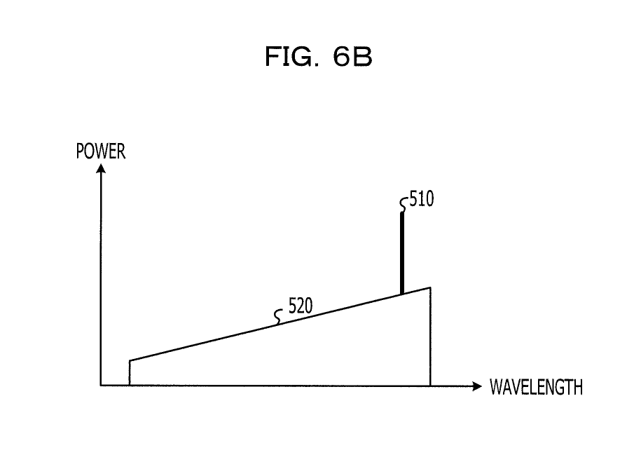

In FIG. 5A, the horizontal axis indicates the wavelength and the vertical axis indicates the optical power (ditto for each of FIGS. 5B, 6A, and 6B). A signal light 510 indicates a signal light included in the light output from the EDF 113. An ASE light 520 indicates an ASE light included in the light output from the EDF 113. When the signal wavelength λ is relatively short, the target value Pedf of the output power of the EDF 113 is determined to be a relatively high value. Consequently, the power of the excitation light input to the EDF 113 is increased.

Accordingly, the wavelength gain characteristic of the EDF 113 becomes substantially or exactly equivalent to the wavelength gain characteristic 303 (see FIG. 3), for example. In consequence, the short wavelength-side gain of the light input to the EDF 113 becomes larger than the long wavelength-side gain of the light input to the EDF 113. Therefore, the gain of the signal light 510 which is a short wavelength is increased and the long wavelength-side gain of the ASE light 520 is reduced. Accordingly, it becomes possible to increase the S/ASE ratio.

FIG. 5B is a graph illustrating another wavelength output characteristic of the EDF 113, the wavelength output characteristic being attained when the signal wavelength is relatively long.

In FIG. 5B, the same properties as those of FIG. 5A are designated by the same reference numerals, and the descriptions thereof will not be furnished. When the signal wavelength λ is relatively long, the target value Pedf of the output power of the EDF 113 is determined to be a relatively low value. Consequently, the power of the excitation light input to the EDF 113 is decreased so that the wavelength gain characteristic of the EDF 113 becomes substantially or exactly equivalent to the wavelength gain characteristic 301 (see FIG. 3), for example.

In consequence, the long wavelength-side gain of the light input to the EDF 113 becomes larger than the short wavelength-side gain of the light input to the EDF 113. Therefore, the gain of the signal light 510 which is a long wavelength is increased and the short wavelength-side gain of the ASE light 520 is reduced. Accordingly, it becomes possible to increase the S/ASE ratio. According to the above-described configuration, the target value Pedf of the output power of the EDF 113 is determined to be a relatively low value. Therefore, the power of a light output from the EDF 113 becomes generally lower than in the case illustrated in FIG. 5A.

FIG. 6A is a graph illustrating a wavelength output characteristic of the VOA 141, the wavelength output characteristic being attained when the signal wavelength is relatively short.

FIG. 6B is another graph illustrating a wavelength output characteristic of the VOA 141, the wavelength output characteristic being attained when the signal wavelength is relatively long. In FIGS. 6A and 6B, the same properties as those of FIGS. 5A and 5B are designated by the same reference numerals, and the descriptions thereof will not be furnished.

Since the excitation light power attained when the signal wavelength λ is relatively short is different from that attained when the signal wavelength λ is relatively long, the power of the light output from the EDF 113, which corresponds to the relatively short signal wavelength λ, is different from that corresponding to the relatively long signal wavelength λ (see FIGS. 5A and 5B). In relation to the above-described power difference, the attenuation amount supplier 143 determines the attenuation amount Lvoa attained with the VOA 141 so that the power of light output from the VOA 141 becomes constant. Consequently, the power of the light output from the VOA 141 becomes constant irrespective of the signal wavelength λ as illustrated in FIGS. 6A and 6B.

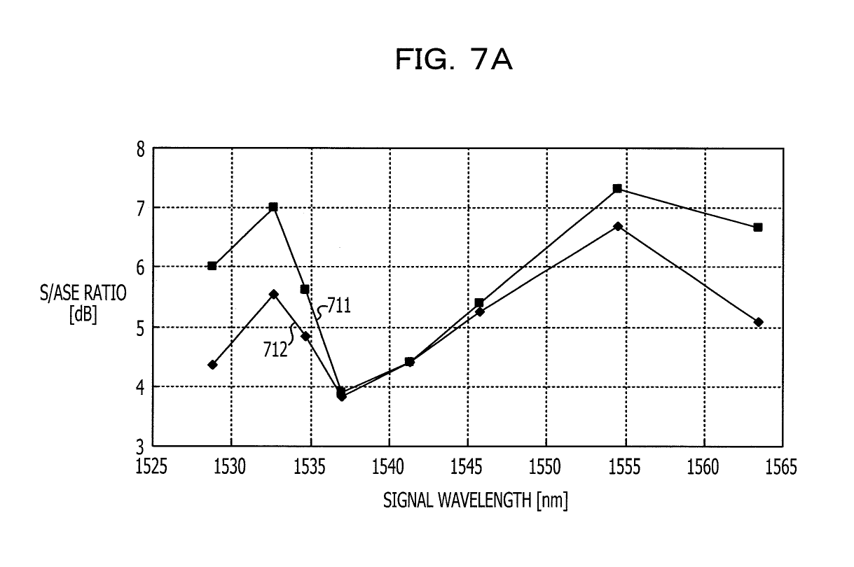

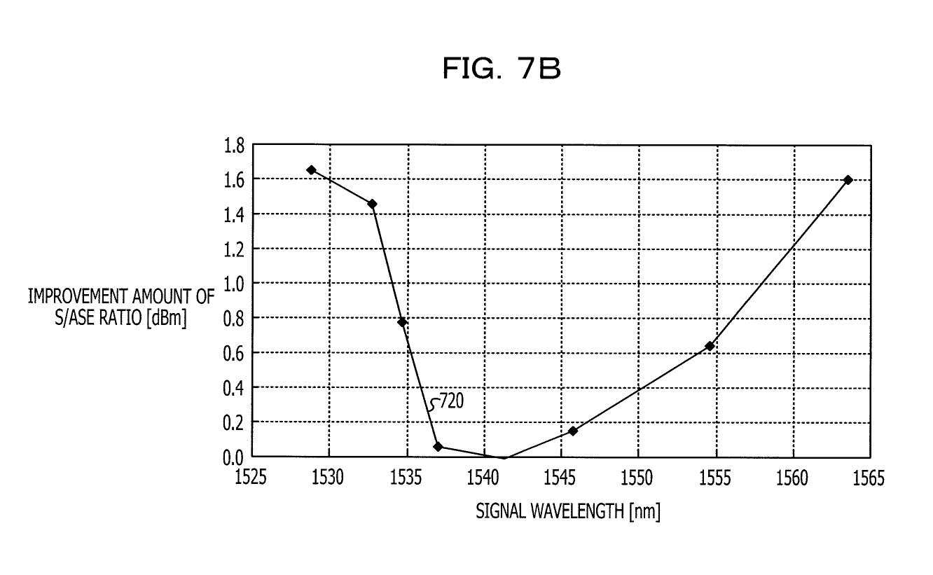

FIG. 7A is a graph illustrating the relationship between the signal wavelength and the S/ASE ratio. In FIG. 7A, the horizontal axis indicates the signal wavelength λ [nm] of a signal light input to the amplification device 100, and the vertical axis indicates the S/ASE ratio [dB] of a signal light output from the amplification device 100. A relationship 711 indicates the relationship between the signal wavelength λ and the S/ASE ratio, which is attained when the output power of the EDF 113 is controlled based on the signal wavelength λ as is the case with the amplification device 100. A relationship 712 indicates the relationship between the signal wavelength λ and the S/ASE ratio for reference, which is attained based on the assumption that the output power of the EDF 113 is not controlled based on the signal wavelength λ as is the case with the amplification devices achieved through the related technologies.

FIG. 7B is a graph illustrating the improvement amount of the S/ASE ratio. In FIG. 7B, the horizontal axis indicates the signal wavelength λ [nm] of a signal light input to the amplification device 100, and the vertical axis indicates the improvement amount [dBm] of the S/ASE ratio of a signal light output from the amplification device 100. A relationship 720 indicates the difference between the relationship 711 and the relationship 712 that are illustrated in FIG. 7A, and indicates the amount of improvement which is made to the S/ASE ratio corresponding to the relationship 712 to attain the S/ASE ratio corresponding to the relationship 711. As indicated by the relationship 720, the amplification device 100 can improve the S/ASE ratio by as much as, for example, 1.5 [dB] when the signal wavelength λ is obtained on the long wavelength-side or the short wavelength-side.

Next, an exemplary method of generating the correspondence information making the signal light wavelength λ and the target value Pedf correspond to each other will be described. According to the exemplary method, the amplification device 100 is applied to a single-wave amplifier having an input of −20 [dBm], an output of 3 [dBm], and a gain of 23 [dB], the single-wave amplifier being used for a WDM communication system operated at wavelength intervals of 50 [GHz] within the C band, where the number of wavelengths is eighty-eight. The excitation light source 111 outputs an excitation light having a wavelength of 0.98 or 1.48 [μm], for example. In the above-descried embodiment, however, the output excitation light has a wavelength of 1.48 [μm].

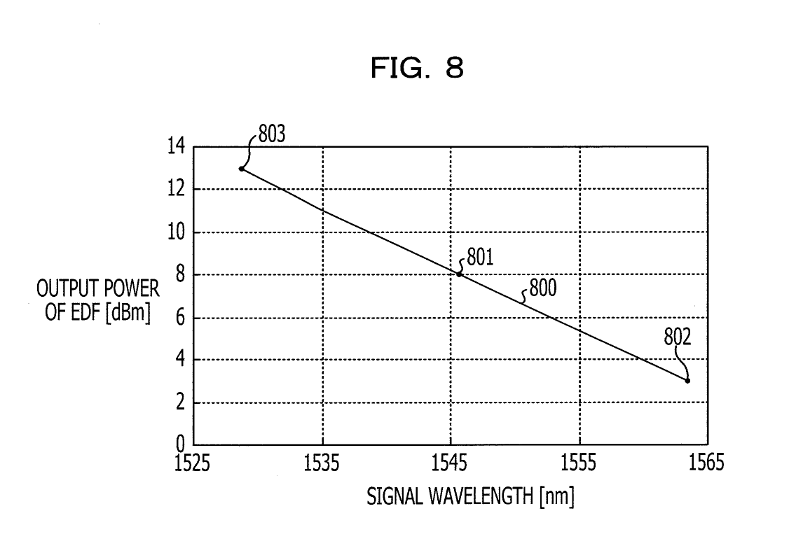

FIG. 8 is a graph illustrating a specific example of the relationship between the signal wavelength and the output power of the EDF 113. In FIG. 8, the horizontal axis indicates the signal wavelength λ [nm] and the vertical axis indicates the output power [dBm] of the EDF 113.

First, assuming that the signal wavelength λ is the center wavelength of the signal band, the value of an attenuation amount Lvoa attained based on the above-described assumption is determined to be 5 [dB], for example. According to the assumption, a gain of 23 [dB]+5 [dB]=28 [dB] is appropriate for the EDF 113. Further, the EDF 113 has a length of, for example, 24 [m] so that the wavelength gain characteristic (see FIG. 3) is leveled off as much as possible when the gain value is 28 [dB]. According to the assumption, the target output of the EDF 113 (target value Pedf) is expressed as the equation 3 [dBm]+5 [dBm]=8 [dBm] (plot point 801).

Next, assuming that the signal wavelength λ is the longest wavelength of the signal band, the value of an attenuation amount Lvoa attained based on the above-described assumption is determined to be 0 [dB], for example. According to the assumption, the target output of the EDF 113 (target value Pedf) is expressed as the equation 3 [dBm]+0 [dBm]=3 [dBm] (plot point 802).

Next, assuming that the signal wavelength λ is the shortest wavelength of the signal band, the value of an attenuation amount Lvoa attained based on the above-described assumption is determined to be 5 [dBm]×2=10 [dB] which is twice as large as the loss of the center wavelength, for example. According to the assumption, the target output of the EDF 113 (target value Pedf) is expressed as the equation 3 [dBm]+10 [dBm]=13 [dBm] (plot point 803).

Next, the line joining the plot points 801 to 803 is determined to be the relationship 800 between the signal wavelength λ and the target value Pedf (as with the relationship 400 illustrated in FIG. 4). Next, correspondence information indicating the relationship 800 is stored in the correspondence information memory 133. Consequently, correspondence information indicating that the target value Pedf is increased as the signal wavelength λ, becomes shorter is generated.

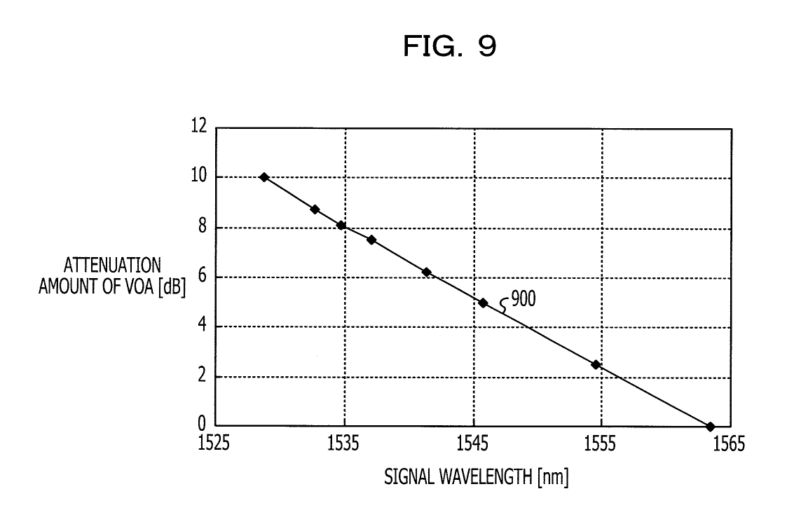

FIG. 9 is a graph illustrating the relationship between the signal wavelength and the attenuation amount of the VOA 141. In FIG. 9, the horizontal axis indicates the signal wavelength λ, [nm] and the vertical axis indicates the attenuation amount Lvoa [dB] of the VOA 141. A relationship 900 illustrates the relationship between the signal wavelength λ and the attenuation amount Lvoa of the VOA 141.

In the amplification device 100, the output power of the EDF 113 is increased as the signal wavelength λ becomes shorter as indicated by the relationship 800 illustrated in FIG. 8, whereas the attenuation amount Lvoa of the VOA 141 is increased as the signal wavelength becomes shorter as indicated by the relationship 900. Therefore, the power of a signal light output from the amplification device 100 is made constant even though the output power of the EDF 113 is changed due to the signal wavelength λ.

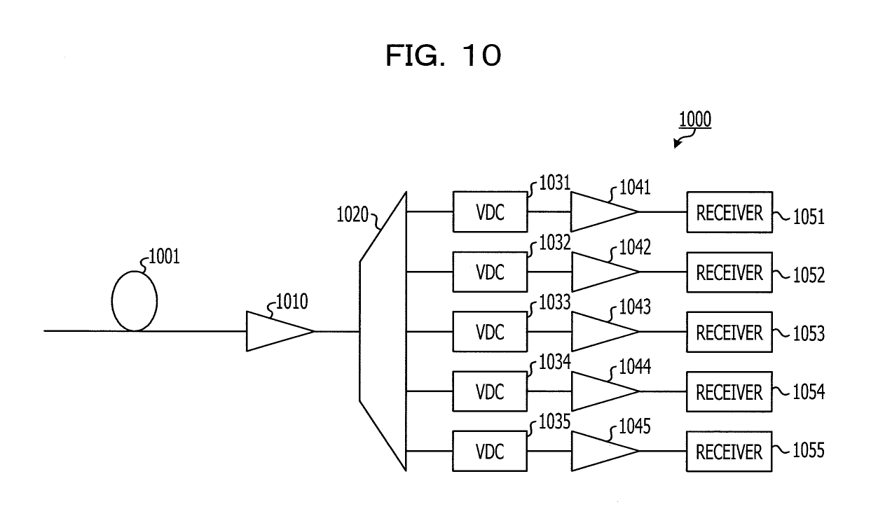

FIG. 10 illustrates a communication system 1000 according to an embodiment. As illustrated in FIG. 10, the communication system 1000 includes a WDM amplifier 1010, an AWG 1020, VDCs 1031, 1032, 1033, 1034, and 1035, optical amplifiers 1041, 1042, 1043, 1044, and 1045, and optical receivers 1051, 1052, 1053, 1054, and 1055. The communication system 100 is a system configured to receive optical signals, each of which is obtained by performing the wavelength multiplexing for a WDM optical signal transmitted via a transfer path 1001.

The WDM amplifier 1010 amplifies the WDM optical signal output from the transfer path 1001 and makes compensation for a loss occurring in the transfer path 1001, for example. The WDM amplifier 1010 outputs the amplified WDM optical signal to the AWG 1020, the AWG 1020 being a demultiplexer performing wavelength multiplexing/demultiplexing for the WDM optical signal output from the WDM amplifier 1010. The AWG 1020 outputs optical signals that are subjected to the wavelength multiplexing/demultiplexing to the individual VDCs 1031 to 1035.

The VDCs 1031 to 1035 are dispersion compensators that are configured to make compensation for the wavelength dispersion of the optical signals that are output from the AWG 1020 and output the optical signals that are subjected to the wavelength dispersion compensation to the individual amplifiers to 1045. The amplifiers 1041 to 1045 amplify the optical signals that are output from the individual VDCs 1031 to 1035 and output the amplified optical signals to the individual receivers 1051 to 1055. The receivers 1051 to 1055 receive the optical signals that are output from the individual amplifiers 1041 to 1045.

Each of the amplifiers 1041 to 1045 may include the amplification device 100 to increase the S/ASE ratio. Consequently, the reception quality of each of the receivers 1051 to 1055 is increased.

In the above-described embodiment, the amplification device 100 is applied to the communication system 1000, which is a WDM communication system. However, without being limited to the WDM communication system, the amplification device 100 can be applied to the reception side of a communication system configured to transmit/receive an optical signal having a single wavelength. In that case, the S/ASE ratio can also be increased with the amplification device 100 and the reception quality can also be increased.

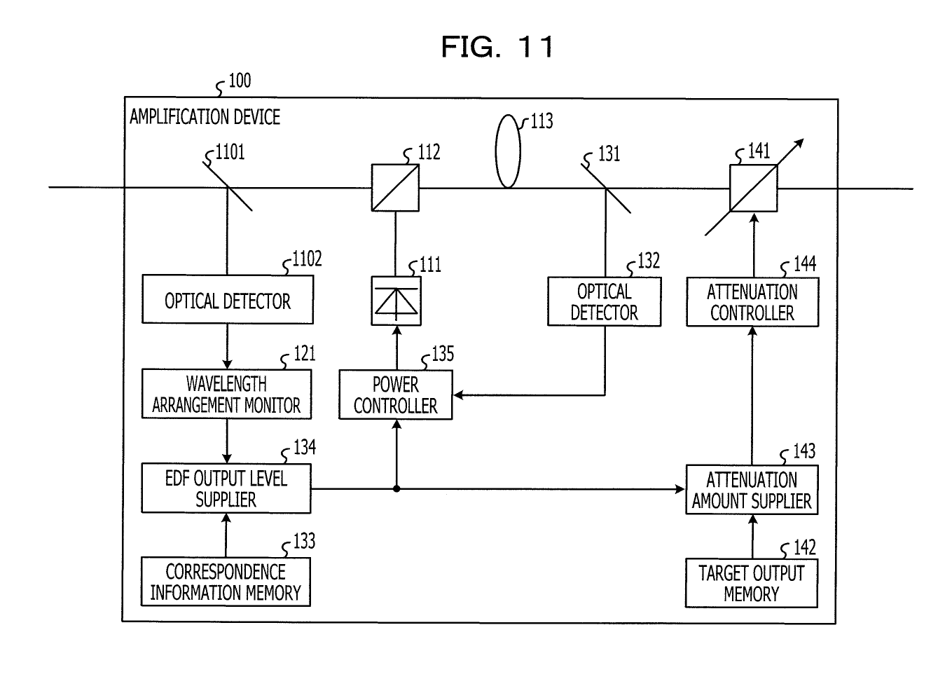

FIG. 11 illustrates an exemplary modification 1 of an amplification device according to an embodiment. In FIG. 11, the same components as those illustrated in FIG. 1 are designated by the same reference numerals and the descriptions thereof will not be furnished. As illustrated in FIG. 11, the amplification device 100 may include a demultiplexer 1101 and an optical detector 1102 in addition to the components that are illustrated in FIG. 1. In the above-described embodiment, a signal light input to the amplification device 100 includes wavelength arrangement information indicating the wavelength of the signal light as a control signal.

The demultiplexer 1101 demultiplexes the wavelength of the control signal from each of the signal lights that are input to the amplification device 100 and that are output to the multiplexer 112, and outputs the demultiplexed control signals to the optical detector 1102 configured to convert a control signal output from the demultiplexer 1101 into an electric signal. The optical detector 1102 outputs the control signal converted into the electrical signal to the wavelength arrangement monitor 121 configured to acquire the wavelength arrangement information from the control signal output from the optical detector 1102. Thus, the optical detector 1102 may receive the wavelength arrangement information as control information transmitted from an external device.

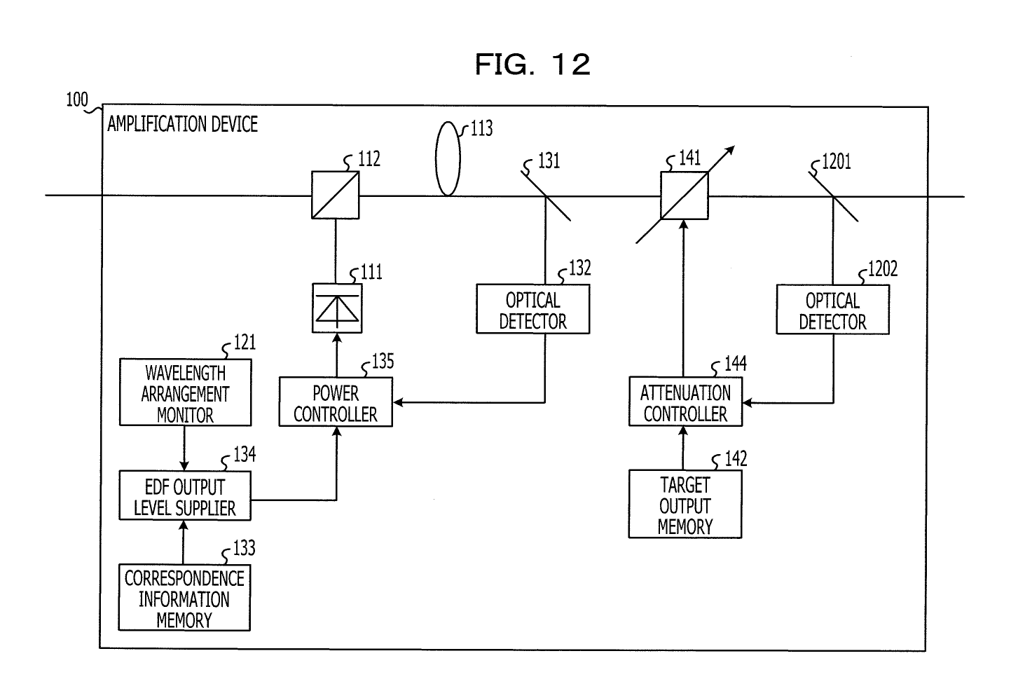

FIG. 12 illustrates an exemplary modification 2 of an amplification device according to an embodiment. In FIG. 12, the same components as those illustrated in FIG. 1 are designated by the same reference numerals and the descriptions thereof will not be furnished. As illustrated in FIG. 12, the amplification device 100 may include a splitter 1201 and an optical detector 1202 in addition to the components that are illustrated in FIG. 1. In the above-described configuration, the attenuation amount supplier 143 illustrated in FIG. 1 may be eliminated.

The splitter 1201 causes a signal light output from the VOA 141 to the anteceding stage of the amplification device 100 to branch, and outputs a signal light obtained through the branching to the optical detector 1202, which is configured to convert the signal light output from the splitter 1201 into an electric signal. The optical detector 1202 outputs the electric signal obtained through the conversion to the attenuation controller 144.

The attenuation controller 144 controls the amount of attenuation performed with the VOA 141 so that the power of the electric signal output from the optical detector 1202 attains the target value Pout of which information is stored in the target output memory 142. Thus, the output power of the VOA 141 may be monitored and the amount of attenuation performed with the VOA 141 may be controlled to make the monitored power constant. In that case, the power of the signal light output from the amplification device 100 can also be made constant (Pout).

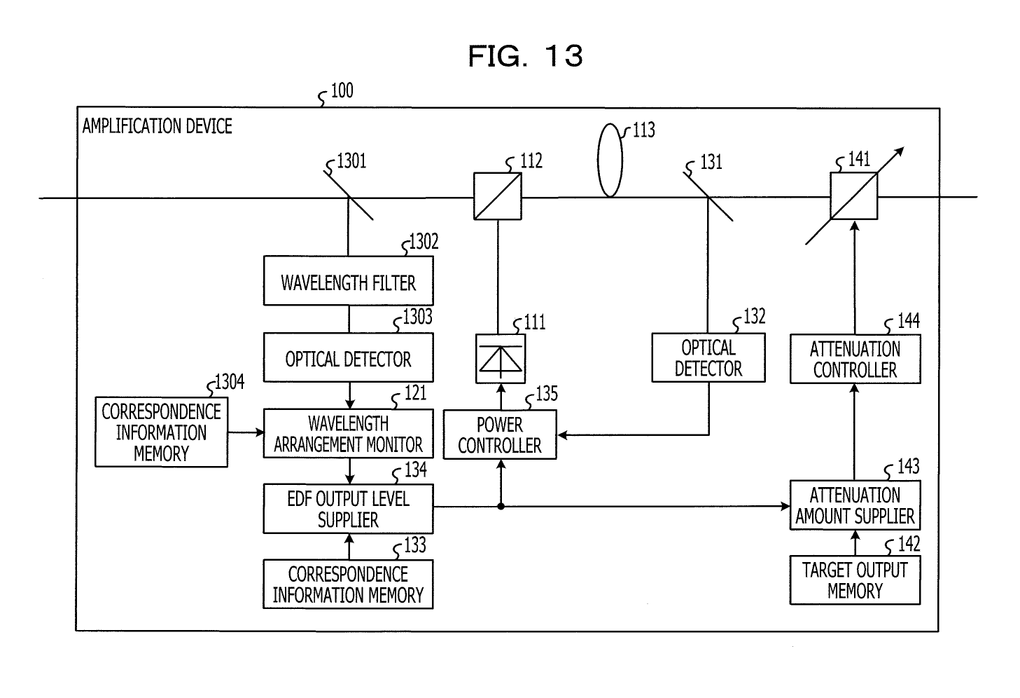

FIG. 13 illustrates an exemplary modification 3 of an amplification device according to an embodiment. In FIG. 13, the same components as those illustrated in FIG. 1 are designated by the same reference numerals and the descriptions thereof will not be furnished. As illustrated in FIG. 13, the amplification device 100 may include a splitter 1301, a wavelength filter 1302, an optical detector 1303, and a correspondence information memory 1304 in addition to the components that are illustrated in FIG. 1. The splitter 1301 is a first splitter configured to cause a signal light that is input to the amplification device 100 and that is output to the multiplexer 112 to branch, and output a signal light obtained through the branching to the wavelength filter 1302.

The wavelength filter 1302 lets the signal light output from the splitter 1301 pass therethrough and outputs the signal light to the optical detector 1303. Further, the wavelength filter 1302 has such a wavelength attenuation characteristic that the attenuation amount varies from one wavelength to another. The optical detector 1303 is a first monitor configured to monitor the power of the signal light that had passed through the wavelength filter 1302. More specifically, the optical detector 1303 converts the signal light output from the wavelength filter 1302 into an electric signal, and outputs the electric signal to the wavelength arrangement monitor 121.

The correspondence information memory 1304 is configured to store correspondence information making the power of the electric signal output from the optical detector 1303 and the signal wavelength λ correspond to each other. The wavelength arrangement monitor 121 acquires the wavelength arrangement information by retrieving information about the signal wavelength λ corresponding to the power of the electric signal output from the optical detector 1303 from the correspondence information stored in the correspondence information memory 1304.

Since the wavelength filter 1302 has the wavelength attenuation characteristic which makes the attenuation amount vary from one wavelength to another, the power of the signal light output from the wavelength filter 1302 and the signal wavelength λ are in the ratio 1:1 so long as the power of a signal light input to the amplification device 100 is constant. Accordingly, the wavelength arrangement monitor 121 can determine the signal wavelength λ based on the correspondence information making the power of the electric signal output from the optical detector 1303 and the signal wavelength λ correspond to each other and the power of the electric signal output from the optical detector 1303. As a consequence, the wavelength arrangement information indicating the signal wavelength λ can be autonomously acquired without setting the wavelength arrangement information in advance or acquiring the wavelength arrangement information from an external device.

The correspondence information stored in the correspondence information memory 1304 can be generated by, for example, inputting a signal light with a known wavelength into the amplification device 100 and monitoring the power of an electric signal output from the optical detector 1303.

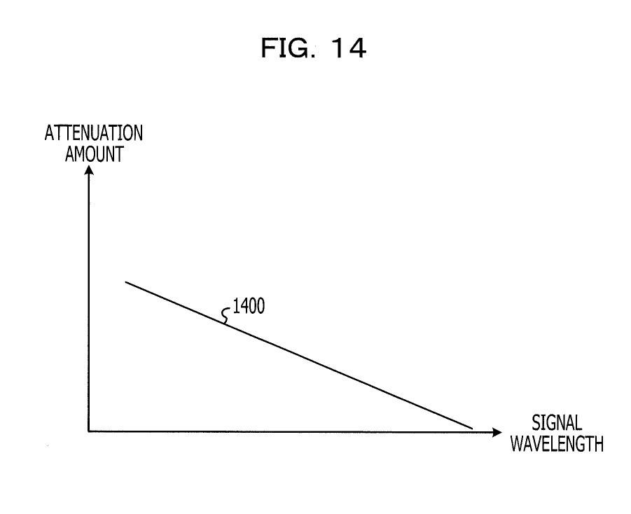

FIG. 14 is a graph illustrating an exemplary wavelength attenuation characteristic 1400 of the wavelength filter 1302. In FIG. 14, the horizontal axis indicates the signal wavelength λ and the vertical axis indicates the amount of attenuation performed with the wavelength filter 1302 illustrated in FIG. 13. The wavelength attenuation characteristic 1400 is the characteristic of the attenuation amount corresponding to the wavelength of a light passing through the wavelength filter 1302. As indicated by the wavelength attenuation characteristic 1400, the wavelength filter 1302 has such a wavelength attenuation characteristic that the attenuation amount against the wavelength becomes a linear gradient.

Accordingly, the power of the signal light output from the wavelength filter 1302 and the signal wavelength λ are in the ratio 1:1 so long as the power of the signal light input to the amplification device 100 is constant. However, without being limited to the wavelength attenuation characteristic 1400, the wavelength filter 1302 may have any wavelength attenuation characteristic so long as the attenuation amount varies from one wavelength to another.

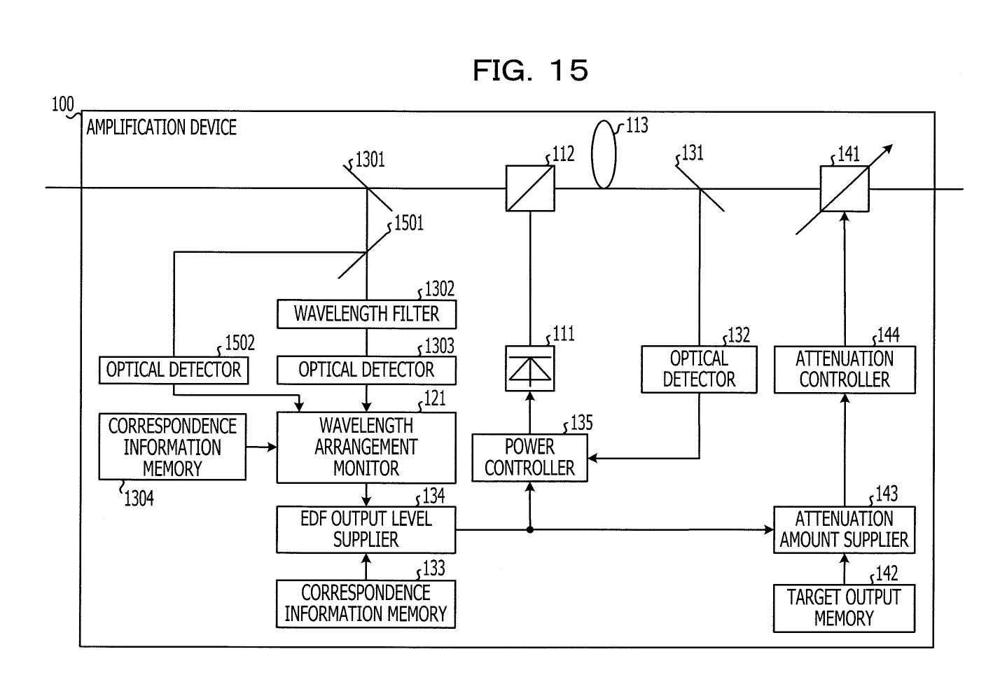

FIG. 15 illustrates an exemplary modification 4 of an amplification device according to an embodiment. In FIG. 15, the same components as those illustrated in FIG. 13 are designated by the same reference numerals and the descriptions thereof will not be furnished. As illustrated in FIG. 15, the amplification device 100 may include a splitter 1501 and an optical detector 1502 in addition to the components that are illustrated in FIG. 13.

The splitter 1501 is a second splitter configured to cause a signal light to branch, the signal light being output from the splitter 1301 to the wavelength filter 1302, and output a signal light obtained through the branching to the wavelength filter 1502. The optical detector 1502 is a second monitor configured to monitor the power of the signal light obtained through the branching performed with the splitter 1501. More specifically, the optical detector 1502 converts the signal light output from the splitter 1501 into an electric signal, and outputs the electric signal to the wavelength arrangement monitor 121.

The correspondence information memory 1304 stores correspondence information making the difference between the power of an electric signal output from the optical detector 1303 and that of an electric signal output from the optical detector 1502, and the signal wavelength λ correspond to each other. The wavelength arrangement monitor 121 acquires the wavelength arrangement information by retrieving information about the signal wavelength 7 corresponding to the above-described difference from the correspondence information stored in the correspondence information memory 1304.

The difference between the power of the electric signal output from the optical detector 1303 and that of the electric signal output from the optical detector 1502 indicates the attenuation amount corresponding to each of the wavelengths of a signal light, the attenuation amount being attained with the wavelength filter 1302. Further, since the wavelength filter 1302 has the wavelength attenuation characteristic which makes the attenuation amount vary from one wavelength to another, the above-described difference and the signal wavelength λ are in the ratio 1:1.

Accordingly, the wavelength arrangement monitor 121 can determine the signal wavelength λ based on the correspondence information making the power of the electric signal output from the optical detector 1303 and the signal wavelength λ correspond to each other, and the difference between the power of the electric signal output from the optical detector 1303 and that of the electric signal output from the optical detector 1502. As a consequence, the wavelength arrangement information indicating the signal wavelength λ can be autonomously acquired even though the power of a signal light input to the amplification device 100 is not constant.

The correspondence information stored in the correspondence information memory 1304 can be generated by, for example, inputting a signal light with a known wavelength into the amplification device 100 and monitoring the difference between the power of the electric signal output from the optical detector 1303 and that of the electric signal output from the optical detector 1502.

Further, the amplification device 100 may be configured to monitor the power of an excitation light input to the EDF 113 and control the power of the excitation light so that the monitoring result attains a target value. In that case, the splitter 131 is provided between the excitation light source 111 and the multiplexer 112, for example. Further, in that case, the correspondence information memory 133 stores correspondence information making the signal wavelength λ and the power of the excitation light input to the EDF 113 correspond to each other.

Even though the above-described amplification device 100 includes the EDF 113 as an optical fiber causing the stimulated emission phenomenon, a different rare-earth doped optical fiber causing the stimulated emission phenomenon may be used in place of the EDF 113. In addition, thulium, praseodymium, and so forth are known as other rare-earth elements that are used for the doping.

Thus, the amplification device 100 according to an embodiment changes the wavelength gain characteristic of an optical fiber by controlling the output power of the EDF 113 based on the signal wavelength, where the output power and a signal light are input to an optical fiber, so that the gain of the signal wavelength is relatively increased. As a consequence, the signal-to-noise ratio (e.g., the S/ASE ratio) can be increased so that the reception quality of a receiver provided in the anteceding stage can be increased.

Thus, the above-described amplification device, communication system, and amplification method can increase the signal-to-noise ratio.

The amplification device, the communication system, and the amplification method that are disclosed herein can increase the signal-to-noise ratio on the optical amplification.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An amplification device comprising:
an amplifier configured to amplify a signal light by inputting the signal light and an excitation light to a rare-earth doped amplification medium;
a wavelength arrangement monitor configured to acquire wavelength arrangement information indicating a wavelength of the signal light; and
a light power controller configured to control power of the input excitation light based on the acquired wavelength arrangement information.

2. The amplification device according to claim 1, wherein when the indicated wavelength is obtained on a short wavelength-side of an amplification band, the light power controller makes power of the excitation power larger than power obtained when the indicated wavelength is obtained on a long wavelength-side of the amplification band.

3. The amplification device according to claim 1, further comprising:
a power monitor configured to monitor power of the amplified signal light, or power of light including the excitation light; and
a first memory configured to store correspondence information making a wavelength of the signal light and a target value of the monitored power correspond to each other,
wherein the light power controller controls the power of the excitation light so that the monitored power attains a target value which is made to correspond to the wavelength indicated by the wavelength arrangement information in the correspondence information stored in the first memory.

4. The amplification device according to claim 1, further comprising:
an attenuator configured to make an amount of attenuation variable, the attenuation being performed for the signal light amplified with the amplifier; and
an attenuation controller configured to control the attenuation amount of the attenuator so that power of a signal light output from the attenuator becomes constant.

5. The amplification device according to claim 3,
wherein the power monitor monitors the power of the signal light amplified with the amplifier, and includes:
an attenuator configured to make an amount of attenuation variable, the attenuation being performed for the signal light amplified with the amplifier;
a second memory configured to store information about a target value of power of a signal light output from the attenuator; and
an attenuation controller configured to control the attenuation amount of the attenuator based on a difference between the target value which is made to correspond to the wavelength and the target value of which information is stored in the second memory.

6. The amplification device according to claim 1, further comprising:
a first splitter configured to cause the signal light to branch;
a wavelength filter that lets a signal light pass through the wavelength filter, the signal light being obtained through the branching performed with the first splitter, and that has such a wavelength attenuation characteristic that an attenuation amount varies from one wavelength to another;
a first power monitor configured to monitor power of the signal light that passed through the wavelength filter; and
a first memory configured to store correspondence information making the power monitored with the first power monitor and a wavelength of the signal light correspond to each other,
wherein the power monitor acquires the wavelength arrangement information based on the power monitored with the first power monitor and the correspondence information stored in the first memory.

7. The amplification device according to claim 6, further comprising:
a first splitter configured to cause the signal light to branch;
a wavelength filter that lets a signal light pass through the wavelength filter, the signal light being obtained through the branching performed with the first splitter, and that has such a wavelength attenuation characteristic that an attenuation amount varies from one wavelength to another;
a first power monitor configured to monitor power of the signal light that passed through the wavelength filter;
a second splitter configured to cause the signal light to branch, the signal light being output from the first splitter to the wavelength filter;
a second power monitor configured to monitor power of a signal light obtained through the branching performed with the second splitter; and
a first memory configured to store correspondence information making a difference between the power monitored with the first monitor and the power monitored with the second monitor, and a wavelength of the signal light correspond to each other,
wherein the power monitor acquires the wavelength arrangement information based on a difference between the power monitored with the first power monitor and the power monitored with the second power monitor, and the correspondence information stored in the first memory.

8. A communication system comprising:
a demultiplexer configured to demultiplex a wavelength multiplexed optical signal;
a plurality of the amplification devices according to claim 1, which is configured to amplify each of optical signals that are obtained through the demultiplexer; and
at least two optical receivers that are configured to receive the individual optical signals that are amplified with the amplification devices.

9. The amplification device according to claim 8, further comprising:
at least two dispersion compensators that are provided in preceding stages of the amplification devices and that make compensation for wavelength dispersions of the individual optical signals.

10. An amplification method comprising:
amplifying a signal light by inputting the signal light and an excitation light to a rare-earth doped amplification medium;
acquiring wavelength arrangement information indicating a wavelength of the signal light with a wavelength arrangement monitor; and
controlling a power of the input excitation light based on the acquired wavelength arrangement information.
